(19) United States
(12) Patent Application Publication
(10) Pub. No.: US 2001/0031637 A1
(43) Pub. Date: Oct. 18, 2001

(54) Information processing system, information processing apparatus and its method, program storage mediun and transmitter

(76) Inventor: Naoya Suzuki, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/775,739

(22) Filed: Feb. 2, 2001

(30) Foreign Application Priority Data
Feb. 4, 2000 (JP) 2000-032815

(51) Int. Cl. H04M 1/00

(52) U.S. Cl. 455/435; 455/558; 455/552; 455/553

(57) ABSTRACT

In an information processing system, an information processing apparatus and its method, a program storage medium and a transmitter, a transmitter transmits the inherent identification information, and an information processing apparatus performs a predetermined process that has been preinstalled, only if the identification information identical to the registered identification information is received. As a result, a user only needs to carry the transmitter to effect the security management of the information processing apparatus without specific operations.

### BACKGROUND OF THE INVENTION

1. Field of the Invention

The present invention relates to an information processing system, an information processing apparatus and its method, a program storage medium and a transmitter, and more particularly, is suitably applied to an information processing system for performing the security management, using the radio, for example.

2. Description of the Related Art

Conventionally, in an information processing apparatus such as a personal computer, a security management method relying on a password has been commonly employed, in which the service is enabled by determining that the proper user has accessed, only if an input password is matched with a registered password in the information processing apparatus.

Also, in the information processing apparatus, there are provided the security management methods, including a card reader type for permitting the access only if a predetermined IC card is inserted into a card reader connected to the information processing apparatus, and a fingerprint collation type for permitting the access only if a registered fingerprint is detected by a fingerprint detecting device connected to the information processing apparatus.

However, an information processing apparatus that involves a security management method relying on a password had the problem that the user has to enter a password from a keyboard or the like to make a troublesome operation, a short password may be liable to incorrect use by analogy, or a long password is difficult for the user to remember, if used to prevent the analogy.

In an information processing apparatus that involves a security management method of card reader type, there was the problem that a card reader must be connected to the information processing apparatus to make a complex configuration, and the user is always required to carry an IC card and insert the IC card into the card reader, resulting in a troublesome operation.

Also, in an information processing apparatus that involves a security management method of fingerprint collation type, there was the problem that a fingerprint detecting device must be connected to the information processing apparatus, making the configuration complex, and the user touches with his/her finger the fingerprint detecting device that detects a fingerprint, resulting in a troublesome operation.

### SUMMARY OF THE INVENTION

In view of the foregoing, an object of this invention is to provide an information processing system for effecting a security management easily, an information processing apparatus and its method, a program storage medium and a transmitter.

The foregoing object and other objects of the invention have been achieved by the provision of an information processing system which comprises: a transmitter for transmitting the inherent terminal identification information; and an information processing apparatus for receiving the terminal identification information and performing a predetermined process that has been preinstalled, only if the received terminal identification information is matched with the registered identification information stored in storage means.

Furthermore, according to the present invention, an information processing apparatus comprises: storage means for storing inherent terminal identification information of a transmitter as registered identification information; request means for transmitting a signal which requests terminal identification information using wireless communication; judging means for judging whether or not the terminal identification information received from the transmitter is matched with the registered identification information stored in the storage means; and process performing means for performing a predetermined process according to the judgement result by the judging means.

Still further, according to the present invention, an information processing method comprises: a request process step of transmitting a signal which requests terminal identification information using wireless communication; a judging process step of judging whether or not the terminal identification information received from the transmitter is matched with the registered identification information stored in the storage means; and a process performing step of performing a predetermined process according to the judgement result by the judging means.

Still further, according to the present invention, a program storage medium for enabling an information processing apparatus to execute a program comprises: a request process step of transmitting a signal which requests terminal identification information using wireless communication; a judging process step of judging whether or not the terminal identification information received from the transmitter is matched with the registered identification information stored in the storage means; and a process performing step of performing a predetermined process according to the judgement result by the judging means.

Still further, according to the present invention, a transmitter comprises: transmitting means for transmitting the inherent terminal identification information to an information processing apparatus which performs a predetermined process that has been preinstalled only if the received terminal identification information is matched with a registered identification information stored in storage means.

Since the predetermined process is performed only if the terminal identification information is matched with the registered identification information, the user only needs to carry a transmitter to make the security management, without any specific operation.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic view illustrating the overall configuration of an information processing system according to the present invention;

FIG. 2 is a block diagram showing a circuit configuration of a notebook type personal computer;

FIG. 3 is a block diagram showing a circuit configuration of a digital portable telephone;

FIG. 4 is a flowchart showing a radio ID registration process;

FIG. 5 is a schematic view showing a security registration key depression request screen; and

FIG. 6 is a flowchart showing a security management process.

### DETAILED DESCRIPTION OF THE EMBODIMENT

Preferred embodiments of this invention will be described with reference to the accompanying drawings:

### (1) Overall configuration of information processing system

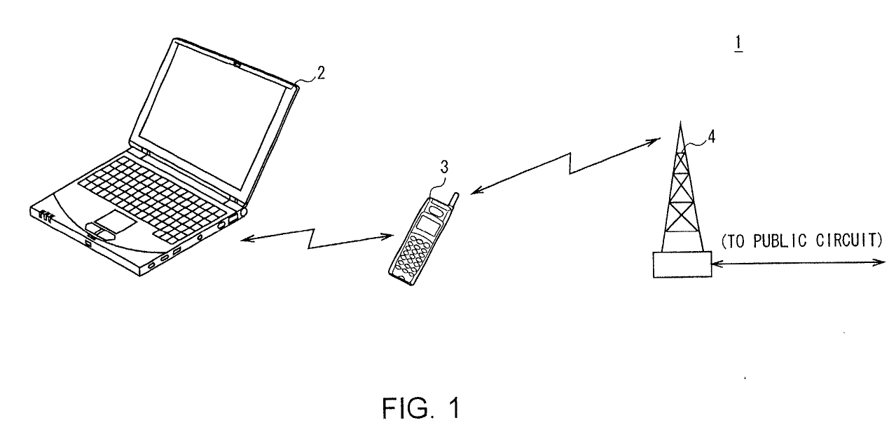

In FIG. 1, reference numeral 1 denotes an information processing system as a whole, to which the present invention is applied. The information processing system 1 comprises a notebook type personal computer (hereinafter referred to as a notebook personal computer) 2 as an information processing apparatus and a digital portable telephone 3.

The digital portable telephone 3 is connected wireless to a base station 4, and can make a variety of kinds of communications including the audio communication and the data communication with other portable telephones or wire telephones which are connected via the base station 4 to the public line (not shown), or various communication terminals such as personal computers or Personal Digital Assistants (PDA). Also, the digital portable telephone 3 has stored a terminal Identifier (ID) that is the terminal identification information inherent to the digital portable telephone 3.

The notebook personal computer 2 and the digital portable telephone 3 are communicated wireless with each other in accordance with the Bluetooth (trademark) that is the radio communication protocol, whereby the notebook personal computer 2 can make various kinds of radio communications with various other communication terminals connected to the public line via the digital portable telephone 3.

Herein, the Bluetooth is the short distance radio data communication protocol standardized by the Bluetooth Special Interest Group (SIG) that is a standardization association, in which 79 channels with a band width of 1 MHz are set up in the Industrial Scientific Medical (ISM) band of 2.4 GHz and, the data transmission of about 10 m is effected at a data transmission rate of 1 Mbit/second (effective value 721 kbit/second), in accordance with a spread spectrum communication system on the basis of a frequency hopping method in which 1600 channels per second are switched.

### (1-1) Configuration of Notebook Personal Computer

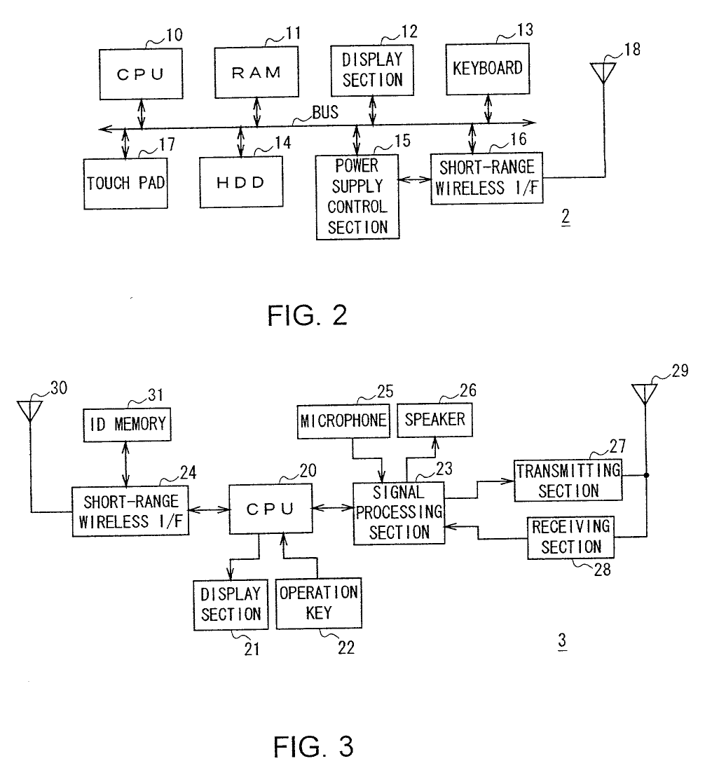

As shown in FIG. 2, the notebook personal computer 2 comprises a CPU 10, a Random Access Memory (RAM) 11, a display unit 12 consisting of a liquid crystal display, a keyboard 13, a hard disk drive (HDD) 14, a power control unit 15, a short distance radio interface 16 in accordance with the Bluetooth protocol, and a touch pad 17, all of which are connected to a data bus BUS.

The HDD 14 stores an operating system program such as Windows 98 (Microsoft Inc., trademark), or the application programs such as a security management program.

The CPU 10 reads out a program stored in the HDD 14 appropriately, expands and executes the program in the RAM 11 to perform various processes and control each circuit unit of the notebook personal computer 2 in accordance with the process, and displays a processed result on the display unit 12.

The power control unit 15 controls the supply of power to each circuit unit of the notebook personal computer 2, in which the power is supplied to the short distance radio interface 16 at any time while the notebook personal computer 2 is inactive.

The short distance radio interface 16 involves the radio data communication with the digital portable telephone 3 (FIG. 1) according to the Bluetooth disposed nearby via an antenna 18.

The short distance radio interface 16 is operating at any time, while the notebook personal computer 2 is inactive. Upon receiving an activation command from the digital portable telephone 3 in an inactive state of the notebook personal computer 2, the short distance radio interface 16 outputs the activation command to the power control unit 15 to start the supply of power to each unit of the notebook personal computer 2, so that the notebook personal computer 2 is activated.

### (1-2) Configuration of Digital Portable Telephone

As shown in FIG. 3, the digital portable telephone 3 has a CPU 20 for controlling the overall operation of the digital portable telephone 3 which is connected to a display unit 21 that is a liquid crystal display, a plurality of operation keys 22, a signal processing unit 23, and a short distance radio interface 24 in accordance with the Bluetooth protocol, the signal processing unit 23 being connected to a microphone 25, a speaker 26, a sending component 27 and a receiving component 28, and the short distance radio interface 24 being connected to a terminal ID memory 31.

The CPU 20 displays on the display unit 21 various kinds of information (e.g., an input telephone number, menu items, a call originating history or a telephone book) in accordance with the instruction information input via the operation key unit 22. Also, the CPU 20 controls the signal processing unit 23 in accordance with the instruction information input via the operation keys 22 to perform various processes including a call originating process and a call release process in accordance with the instruction information.

In practice, the digital portable telephone 3 is a cellular portable telephone of Code Division Multiple Access (CDMA) system in accordance with a Direct Sequence (DS) method corresponding to the IS95 standards. The signal processing unit 23 makes an error correcting operation in accordance with the Cyclic Redundancy Check (CRC) method for an audio signal input from the microphone 25 during conversation, a convolutional coding operation, a multiplication of Pseudo Noise (PN) code, a frequency diffusion, and a Quadrature Phase Shift Keying (QPSK) modulation to generate a sending symbol stream, which is then passed to the sending component 27. The sending component 27 generates a sending signal by converting the sending symbol stream from digital to analog form, makes the frequency conversion for the sending signal, and amplifies the sending signal, which is then sent via the antenna 29.

On the other hand, the receiving component 28 receives a signal via the antenna 29, and makes the amplification for the received signal, frequency conversion, and analog/digital conversion to generate a received symbol stream, which is then passed to the signal processing unit 23. The signal processing unit 23 makes a QPSK demodulation for the received symbol stream, a multiplication of a PN code, inverse diffusion, a maximum likelihood series estimation using a convolutional code, and an error detecting operation in accordance with the CRC method to generate an audio signal, which is then output from the speaker 26.

Also, the signal processing unit 23 makes a call originating operation by sending a control signal from the sending component 27 via the antenna 29 to the base station 4 (FIG. 1) under the control of the CPU 20, and notifies the CPU 20 of a call incoming signal which is received by the receiving component 28 via the antenna 29.

The CPU 20 controls the signal processing unit 23 to make the radio data communication with other communication terminals connected to the public line, using the sending component 27 and the receiving component 28 and via the antenna 29.

Also, the CPU 20 controls the short distance radio interface 24 to make the radio data communication with the notebook personal computer 2 (FIG. 1) according to the Bluetooth that is disposed nearby via the antenna 30.

Further, the CPU 20 exchanges the communication data between the signal processing unit 23 and the short distance radio interface 24, thereby enabling the radio data communication between the notebook personal computer 2 and other communication terminals (not shown) connected to the public line via the digital portable telephone 3.

The terminal ID memory 31 stores a terminal ID inherent to the digital portable telephone 3. The CPU 20 reads the terminal ID from the terminal ID memory 31 in response to a terminal ID transmission request issued from the notebook personal computer 2 (FIG. 1), or user's depression of a security registration key (not shown) of the operation key unit 22, and sends the terminal ID via the short distance radio interface 24 to the notebook personal computer 2.

### (2) Security Management Method

A security management method in the information processing system 1 will be described below.

### (2-1) Terminal ID Registration Process

In the information processing system 1, when the security management is made using a security management program, the user first registers the terminal ID of the digital portable telephone 3 owned by the user in the security management program of the notebook personal computer 2.

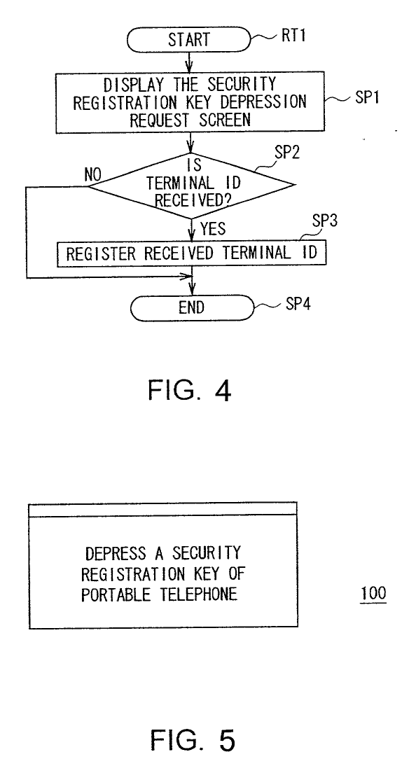

In accordance with the security management program, the notebook personal computer 2 enters a start step of a routine RT1 and then passes to step SP1, as shown in FIG. 4. At step SP1, the CPU 10 displays on the display unit 12 a security registration key depression request screen 100, as shown in FIG. 5, and instructs the user to depress a security registration key of the digital portable telephone 3.

If the security registration key of the digital portable telephone 3 is depressed by the user, the CPU 20 of the digital portable telephone 3 reads a terminal ID from the terminal ID memory 31 in response to this depression and sends the terminal ID via the short distance radio interface 24 to the notebook personal computer 2.

At step SP2, the CPU 10 of the notebook personal computer 2 makes an inquiry to the short distance radio-interface 16, and determines whether or not the radio ID has been received from the digital portable telephone 3.

If a negative answer is obtained at step SP2, this means that the user has not depressed a security registration key of the digital portable telephone 3, or the short distance radio interface 16 has not received the terminal ID because the digital portable telephone 3 is out of the communication range of the notebook personal computer 2 in accordance with the Bluetooth. Then, the CPU 10 transfers to step SP4 where the processing is ended. On the contrary, if an affirmative answer is obtained at step SP2, this means that the radio ID has been received from the digital portable telephone 3, whereby the CPU 10 transfers to the next step SP3.

At step SP3, the CPU 10 registers the received terminal ID as the registered ID in the security management program, and then transfers to the next step SP4, where the terminal ID registration process is ended.

Through the above process, the terminal ID of the digital portable telephone 3 is registered as the registered ID that is a security key for the notebook personal computer 2 in the security management program, whereby a radio security function of the security management program becomes effective from the next time of activating the notebook personal computer 2.

### (2-2) Security Management Process with Security Management program

In the information processing system 1 according to the present invention, the security management program is activated in parallel with the activation of an operating system in a state where the radio security function is effective, when the notebook personal computer 2 is activated.

The notebook personal computer 2 transmits a terminal ID transmission request to the digital portable telephone 3 via the short distance radio interface 16 in accordance with the security management program. In the case where the digital portable telephone 3 is present within the communication range of the notebook personal computer 2 in accordance with the Bluetooth, the digital portable telephone 3 reads an inherent terminal ID from the terminal ID memory 31 in response to the terminal ID transmission request, and sends this terminal ID via the short distance radio interface 24 to the notebook personal computer 2.

The notebook personal computer 2 determines that the activation operation has been made by the proper user, only if the received terminal ID from the digital portable telephone 3 is matched with the registered ID registered in the security management program, and completes the activation of the operating system.

On the contrary, if the received terminal ID is unmatched with the registered ID, or if the terminal ID is not received, the notebook personal computer 2 determines that the activation operation has not been made by the proper user, and immediately stops the activation of the operating system.

Also, the notebook personal computer 2 transmits a terminal ID transmission request repetitively at a predetermined interval during its operation, and determines that the proper user is not present near the notebook personal computer 2, if the received terminal ID is unmatched with the registered ID registered in the security management program, or if the terminal ID cannot be received. Thereby the notebook personal computer 2 suspends the screen display indicating the processed contents, as well as inhibiting the accept of key inputs from the keyboard 13 to disable the operation of the notebook personal computer 2. And the notebook personal computer 2 also transmits the terminal ID transmission request repetitively at a predetermined interval in this state. When the terminal ID identical to the registered ID is received, the notebook personal computer 2 determines that the proper user is present again near the notebook personal computer 2, and then resumes the screen display and the accept of key inputs.

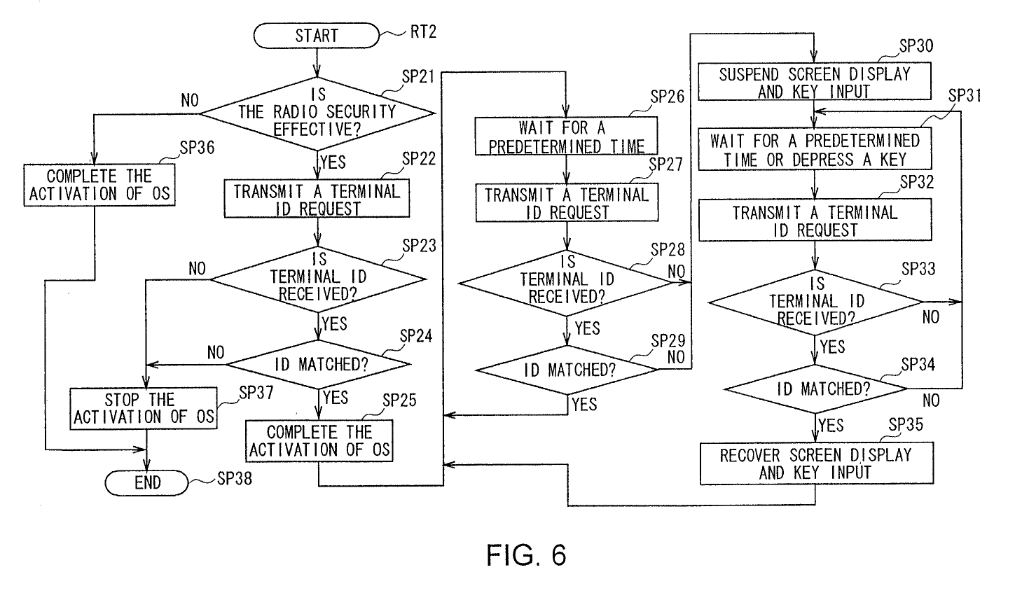

In accordance with the security management program, the notebook personal computer 2 enters a start step of a routine RT2 and then passes to step SP21, as shown in FIG. 6. At step SP21, the CPU 10 determines whether or not the radio security function of the security management program is effective.

If a negative answer is obtained at step SP21, this means that the registered ID is not registered in the security management program, and the radio security function is ineffective. Then the CPU 10 transfers to step SP36, where the activation of the operating system is completed. The process is ended at step SP38.

On the contrary, if an affirmative answer is obtained at step SP21, this means that the registered ID has been registered in the security management program and the radio security function is effective. Then, the CPU 10 transfers to step SP22 to transmit a terminal ID transmission request to the digital portable telephone 3.

In this state, if the digital portable telephone 3 is present within the communication range of the notebook personal computer 2 in accordance with the Bluetooth, the digital portable telephone 3 reads an inherent terminal ID from the terminal ID memory 31 in response to the terminal ID transmission request, and sends this terminal ID via the short distance radio interface 24 to the notebook personal computer 2.

At step SP23, the CPU 10 makes an inquiry to the short distance radio interface 16, and determines whether or not the terminal ID has been received from the digital portable telephone 3.

If a negative answer is obtained at step SP23, this means that the short distance radio interface 16 has not received the terminal ID from the digital portable telephone 3, namely, the digital portable telephone 3 is out of the communication range of the notebook personal computer 2 in accordance with the Bluetooth to cause the activation operation not to be performed by the proper user. Then the CPU 10 transfers to step SP37 to stop the activation of the operating system. The process is ended at step SP38.

On the contrary, if an affirmative answer is obtained at step SP23, this means that the short distance radio interface 16 has received the terminal ID from the digital portable telephone 3, whereby the CPU 10 transfers to the next step SP24.

At step SP24, the CPU 10 determines whether or not the received terminal ID is matched with the registered ID registered in the security management program.

If a negative answer is obtained at step SP24, this means that the received terminal ID is unmatched with the registered ID, namely, the activation operation has not been performed by the proper user. Then the CPU 10 transfers to step SP37 to stop the activation of the operating system, and turn off the power of the notebook personal computer 2. The process is ended at step SP38.

On the contrary, if an affirmative answer is obtained at step SP24, this means that the received terminal ID is matched with the registered ID, namely, the activation operation has been performed by the proper user. Then the CPU 10 transfers to the next step SP25 to complete the activation of the operating system.

In this way, in the case where the radio security function is effective, the notebook personal computer 2 transmits a terminal ID transmission request to the digital portable telephone 3, when activated, and completes the activation of the operating system only if the terminal ID identical to the registered ID registered in the security management program is received from the digital portable telephone 3.

At step SP26, the CPU 10 waits for a predetermined time, and after the elapse of the predetermined time, then transfers to the next step SP27.

At step SP27, the CPU 10 transmits a terminal ID transmission request again to the digital portable telephone 3, and then transfers to the next step SP28.

At step SP28, the CPU 10 makes an inquiry to the short distance radio interface 16, and determines whether or not the terminal ID has been received from the digital portable telephone 3 within the predetermined time.

If a negative answer is obtained at step SP28, this means that the short distance radio interface 16 has not received the terminal ID. Then the CPU 10 transfers to step SP30.

On the contrary, if an affirmative answer is obtained at step SP28, this means that the short distance radio interface 16 has received the terminal ID. Then the CPU 10 transfers to step SP29.

At step SP29, the CPU 10 determines whether or not the received terminal ID is matched with the registered ID registered in the security management program.

If an affirmative answer is obtained at step SP29, this means that the received radio ID is matched with the registered ID, namely, the digital portable telephone 3 is within the communication range of the notebook personal computer 2 in accordance with the Bluetooth, and the proper user is present near the notebook personal computer 2. Then the CPU 10 repeats again the operation from step SP26 to step SP29.

On the contrary, if a negative answer is obtained at step SP29, this means that the received radio ID is unmatched with the registered ID. Then the CPU 10 transfers to step SP30.

At step SP30, the CPU 10 suspends the screen display of the display unit 12, and inhibits the accept of key inputs from the keyboard 13 to disable the operation of the notebook personal computer 2. The CPU 10 transfers to the next step SP31.

At step SP31, the CPU 10 waits again for a predetermined time. If the predetermined time has elapsed, or any key is depressed from the keyboard 13, the CPU 10 transfers to the next step SP32.

At step SP32, the CPU 10 transmits a terminal ID transmission request to the digital portable telephone 3. Then the CPU 10 transfers to the next step SP33.

At step SP33, the CPU 10 makes an inquiry to the short distance radio interface 16, and determines whether or not the terminal ID has been received from the digital portable telephone 3 within the predetermined time.

If a negative answer is obtained at step SP33, this means that the short distance radio interface 16 has not received the terminal ID. Then the CPU 10 transfers to step SP31.

On the contrary, if an affirmative answer is obtained at step SP33, this means that the short distance radio interface 16 has received the terminal ID. Then the CPU 10 transfers to the next step SP34.

At step SP34, the CPU 10 determines whether or not the received terminal ID is matched with the registered ID registered in the security management program.

If a negative answer is obtained at step SP34, this means that the received radio ID is unmatched with the registered ID. Then the CPU 10 transfers to step SP31.

On the contrary, if an affirmative answer is obtained at step SP34, this means that the received radio ID is matched with the registered ID, namely, the digital portable telephone 3 is within the communication range of the notebook personal computer 2 in accordance with the Bluetooth, and the proper user is present again near the notebook personal computer 2. Then the CPU 10 transfers to the next step SP35.

At step SP35, the CPU 10 resumes the screen display of the display unit 12, and enables the accept of key inputs from the keyboard 13 again to permit the operation of the notebook personal computer 2. Then the CPU 10 transfers to step SP26 and subsequent steps.

In this way, the notebook personal computer 2 repeats the processing from step SP26 to step SP35 during its operation, until the digital portable telephone 3 is not present within the communication range of the notebook personal computer 2 in accordance with the Bluetooth. At this time, the notebook personal computer 2 suspends the screen display of the display unit 12 and inhibits the accept of key inputs from the keyboard 13, thereby surely preventing the improper user from employing the notebook personal computer 2.

In this way, the notebook personal computer 2 transmits a terminal ID transmission request to the digital portable telephone 3 in accordance with the security management program, when activated, and during its operation. And the notebook personal computer 2 determines that the proper user is present near the notebook personal computer 2, only if the terminal ID sent from the digital portable telephone 3 is matched with the registered ID registered in the security management program.

### (3) Operation and Effect of Embodiment

With the above configuration, the notebook personal computer 2 transmits a terminal ID transmission request to the digital portable telephone 3, when activated. The notebook personal computer 2 determines that the activation operation has been performed by the proper user, only if the received terminal ID is matched with the registered ID registered in the security management program. Then the notebook personal computer 2 completes the activation of the operating system.

The notebook personal computer 2 transmits a terminal ID transmission request to the digital portable telephone 3 at a predetermined interval during its operation. The notebook personal computer 2 determines that the user is not present near the notebook personal computer 2, if the terminal ID has not been received, or the received terminal ID is unmatched with the registered ID. The notebook personal computer 2 suspends the screen display and inhibits the accept of key inputs, thereby preventing the improper user from employing the notebook personal computer 2.

With the above configuration, the security management of the notebook personal computer 2 when activated and during its operation is performed, on the basis of the terminal ID of the digital portable telephone 3. The user only needs to carry the digital portable telephone 3 to effect the security management of the notebook personal computer 2 without specific operations.

### (4) Other Embodiments

In the above embodiment, the short distance radio interface according to the Bluetooth was employed as communication means between the digital portable telephone 3 and the notebook personal computer 2. However, the present invention is not limited thereto, but the digital portable telephone 3 and the notebook personal computer 2 can be connected via various communication means, for example, short distance radio communication means such as a Home Radio frequency (HomeRF) as defined in Institute of Electrical and Electronics Engineers (IEEE) 802.11, or infrared communication means as defined in the Infrared Data Association (IrDA).

In the above embodiment, the security management program is activated at the time of activating the notebook personal computer 2. However, this invention is not limited thereto, but the security management program can be activated, for example, upon activating an application program for which a security is particularly needed, to effect the security management only for the application program for which the security is needed.

In the above embodiment, in the case where the terminal ID identical to the registered ID is not received during the operation of the notebook personal computer 2, the screen display is suspended and the accept of key inputs is inhibited. However, this invention is not limited thereto, but the power of the notebook personal computer 2 can be turned off.

In the above embodiment, in the case where the terminal ID identical to the registered ID has not been received, the activation of the notebook personal computer 2 is stopped, the screen display is suspended, and the accept of key inputs are disabled. However, this invention is not limited thereto, but even in the case where the terminal ID identical to the registered ID is received, the activation of the notebook personal computer 2 can be stopped, the screen display can be suspended, and the accept of key inputs can be disabled, if the reception level of the received terminal ID is not beyond a predetermined threshold.

In the above embodiment, the security management of the notebook personal computer 2 is made on the basis of the terminal ID of the digital portable telephone 3. However, this invention is not limited thereto, but the security management of the notebook personal computer 2 can be made, for example, on the basis of the telephone number of the digital portable telephone 3.

In the above embodiment, the digital portable telephone 3 is provided with the short distance radio interface 16, and the security management of the notebook personal computer 2 is made by transmitting the terminal ID from the digital portable telephone 3. However, this invention is not limited thereto, but the short distance radio interface 16 can be provided on various kinds of portable equipment, for example, the portable information equipment such as a pager (e.g., a so-called Pocket Bell) or the portable audio equipment such as a headphone stereo tape recorder to transmit the terminal ID. Alternatively, the terminal ID can be transmitted from the personal belongings such as a key holder. In essence, the terminal ID can be transmitted from the equipment that the user always carries.

In the above embodiment, the digital portable telephone 3 is a cellular portable telephone of the CDMA method. However, this invention is not limited thereto, but the Wideband-CDMA (W-CDMA) method or Time division Multiple Access (TDMA) method can be employed. Further, the International Mobile Telecommunication System (IMT) -2000 method in the next generation portable telephone system can be employed.

Further, in the above embodiment, the CPU 10 makes the security management in accordance with the security management program stored in the HDD 14. However, this invention is not limited thereto, but the security management program can be stored in various kinds of program storage media, and the security management program can be installed into the notebook personal computer 2, using the program storage medium to make the security management.

The program storage medium for enabling the security management program to be installed into the notebook personal computer 2 and executed by the notebook personal computer 2 can be, not only the package media such as a floppy disk and a Digital Versatile Disc-Read Only Memory (DVD-ROM), but also a semiconductor memory or a magnetic disk where the program is stored temporarily or permanently. As means for storing an originator information display program in the program storage medium, wire or wireless communication means can be employed, such as a local area network, the Internet, or the digital satellite broadcasting, or via various kinds of interfaces such as a router or a modem.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. An information processing system comprising:
a transmitter for transmitting the inherent terminal identification information; and
an information processing apparatus for receiving said terminal identification information, and performing a predetermined process that has been preinstalled, only if said received terminal identification information is matched with the registered identification information registered in storage means.

2. The information processing system according to claim 1 wherein said information processing apparatus makes a request for said transmitter to transmit said terminal identification information and said transmitter transmits said terminal identification information in accordance with said request.

3. The information processing system according to claim 2 wherein said information processing apparatus makes a request to transmit said terminal identification information, when activated, and continues and completes an activation process of said information processing apparatus, only if said received terminal identification information is matched with the registered identification information.

4. The information processing system according to claim 2 wherein said information processing apparatus makes a request to transmit said terminal identification information, while in operation, and continues the operation of said information processing apparatus, only if said received terminal identification information is matched with the registered identification information.

5. The information processing system according to claim 1 wherein said information processing apparatus performs said predetermined process when a reception level of said received terminal identification information is not less than a predetermined threshold.

6. The information processing system according to claim 1 wherein said transmitter is a digital portable telephone.

7. The information processing system according to claim 6 wherein the inherent identification information of said transmitter is a telephone number of said digital portable telephone.

8. An information processing apparatus comprising:
storage means for storing inherent terminal identification information of a transmitter as registered identification information;
request means for transmitting a signal which requests terminal identification information using wireless communication;
judging means for judging whether or not said terminal identification information received from said transmitter is matched with the registered identification information stored in said storage means; and
process performing means for performing a predetermined process according to the judgement result by said judging means.

9. The information processing apparatus according to claim 8 wherein said request means requests said terminal identification information every predetermined period of time.

10. The information processing apparatus according to claim 8 wherein said judging means, after said request means requests said terminal identification information, judges said terminal identification information received within a stated period of time.

11. The information processing apparatus according to claim 9 wherein said process performing means, when said judging means judges that said terminal identification information is not matched with said registered identification information, does not accept input to said information processing apparatus.

12. The information processing apparatus according to claim 9 wherein said process performing means, when said terminal identification information is not received within said stated period of time, does not accept input to said information processing apparatus.

13. The information processing apparatus according to claim 9 wherein said process performing means, when said judging means judges that said terminal identification information is not matched with said registered identification information, suspends the display of said information processing apparatus.

14. The information processing apparatus according to claim 8 wherein said request means, when a user instructs to perform a predetermined process, transmits a signal which requests said terminal identification information.

15. The information processing apparatus according to claim 14 wherein said process performing means, when said judging means judges that said terminal identification information is matched with said registered identification information, continues said predetermined process according to the instruction of the user.

16. An information processing method comprising:
a request process step of transmitting a signal which requests terminal identification information using wireless communication;
a judging process step of judging whether or not said terminal identification information received from said transmitter is matched with the registered identification information stored in said storage means; and
a process performing step of performing a predetermined process according to the judgement result by said judging means.

17. The information processing method according to claim 16 wherein said request process step comprises requesting said terminal identification information every predetermined period of time.

18. The information processing method according to claim 16 wherein said request process step comprises, when a user instructs to perform a predetermined process, requesting said terminal identification information.

19. The information processing method according to claim 16 wherein said process performing step comprises, when it is judged in said judging process step that said terminal identification information is not matched with said registered identification information, not accepting input to said information processing apparatus.

20. The information processing method according to claim 16 wherein said process performing step comprises, when it is judged in said judging process step that said terminal identification information is not matched with said registered identification information, suspending the display of said information processing apparatus.

21. A program storage medium for enabling an information processing apparatus to execute a program, said program comprising:
a request process step of transmitting a signal which requests terminal identification information using wireless communication;
a judging process step of judging whether or not said terminal identification information received from said transmitter is matched with the registered identification information stored in said storage means; and
a process performing step of performing a predetermined process according to the judgement result by said judging means.

22. The program storage medium for enabling an information processing apparatus to execute a program according to claim 21 wherein said request process step comprises requesting said terminal identification information every predetermined period of time.

23. The program storage medium for enabling an information processing apparatus to execute a program according to claim 21 wherein said request process step comprises, when a user instructs to perform a predetermined process, requesting said terminal identification information.

24. The program storage medium for enabling an information processing apparatus to execute a program according to claim 21 wherein said process performing step comprises, when it is judged in said judging process step that said terminal identification information is not matched with said registered identification information, not accepting input to said information processing apparatus.

25. The program storage medium for enabling an information processing apparatus to execute a program according to claim 21 wherein said process performing step comprises, when it is judged in said judging process step that said terminal identification information is not matched with said registered identification information, suspending the display of said information processing apparatus.

26. A transmitter comprising:
transmitting means for transmitting the inherent terminal identification information to an information processing apparatus which performs a predetermined process that has been preinstalled only if the received terminal identification information is matched with a registered identification information stored in storage means.
